(19) United States
(12) Patent Application Publication
(10) Pub. No.: US 2012/0150666 A1
(43) Pub. Date: Jun. 14, 2012

(54) Methods And Systems For Providing Side-Tab Widgets To Enable Web-Based Advertising And E-Commerce Transactions

(76) Inventor: Aleksandar Savic, Zurich (CH)

(21) Appl. No.: 13/324,139

(22) Filed: Dec. 13, 2011

Related U.S. Application Data
(60) Provisional application No. 61/459,498, filed on Dec. 14, 2010.

(51) Int. Cl. G06Q 30/02; G06Q 30/00

(52) U.S. Cl. 705/14.73; 705/26.41

(57) ABSTRACT

Systems and methods for improving online shopping allow customers to directly access a merchant's product offerings (and/or advertisements) from a third party, publisher's web page, without having to “click through” to the merchant's website. The systems and methods include the use of one or more “side-tab widgets”, each of which may be associated with a merchant, that are displayed on a publisher's web site or page. The display creates a presence for the merchant or merchants associated with the widget or widgets on the publisher's web page. Thereafter, if a widget is viewed and selected by a customer by clicking on the widget the selected side-tab widget may slide out and display information specific to the merchant, including goods offered for sale and the means (i.e., shopping cart) to allow the customer to immediately complete a transaction or purchase.

### CROSS-REFERENCE TO RELATED APPLICATIONS

This application claims the benefit of priority of U.S. Provisional Application No. 61/459,498, filed Dec. 14, 2010 and incorporates by reference herein, as if set forth in full herein, the contents of U.S. Provisional Application No. 61/459,498.

### TECHNICAL FIELD

The present invention relates to online advertising and sales and, more particularly, to the utilization of a side-tab widget that is displayed on a publisher's web page and activated to bring up a particular merchant's advertising/“shopping cart” page.

### BACKGROUND

Online shopping continues to be a popular activity, particularly with the proliferation of more types of web-enabled devices. Currently there are thousands of websites for commercial products and services that are being offered for sale (generally referred to as “e-commerce sites”). A basic, ubiquitous feature of each of these sites is the utilization of a virtual “shopping cart”. Generally, these shopping carts are server-side software applications that enable customers that are browsing a merchant's website to conveniently select and purchase items offered for sale on the website. Shopping cart software typically generates separate web pages that are presented to the customer, displaying a listing of the items being purchased, quantity, price, etc. Various follow-on pages are then utilized to exchange financial and shipping information to complete the transaction.

Although the web-based shopping carts have been useful in making online shopping a “user-friendly” experience, their current implementation presents some limitations. For example, as currently implemented, a shopping cart is necessarily tied to a particular merchant's website. There is no ability for sales to occur once a customer leaves a particular merchant's site. Looked at from another perspective, if an online entity such as a publisher lists product offerings from multiple merchants (or displays items from other merchants in banner ads), a customer must “click through” the publisher's website, and then separately enter the merchant's website (waiting, at times, for the merchant's website to load) to then begin shopping.

By requiring the customer to be redirected from a publisher's site to the merchant's site, it is known that a significant number of potential customers will be discouraged from completing the transaction—the sale is lost. It has been reported that, about half of the time a potential customer will decline from continuing with a transaction, if he/she needs to click-through from a first site to a second site in order to complete the transaction or a purchasing process.

Given the popularity of online shopping and the ubiquitous presence of the shopping cart as the means of executing online shopping, a need remains to overcome the impediments associated with the redirecting of customers to a merchant's specific website in order to initiate or complete a transaction or purchase.

### SUMMARY

Embodiments of the invention are provided that are directed at methods and systems for generating one or more side-tab widgets associated with a merchant and controlling the display of the one or more widgets, for example, on a publisher's web page. When a side-tab widget is generated and displayed it may, thereafter, be selected by a user/customer viewing the web page to activate functions that may be used to expedite online shopping with the merchant, bypassing the need for the customer to “click-through” from the publisher's website to the merchant's website to initiate a transaction. The side-tab widget may contain advertisements, take the form of a shopping cart, or have elements of both. Control of the side-tab widget's position within a web page is such that its position within the page is unobtrusive and does not compromise a user's browsing experience on the publisher's website. Indeed, multiple merchants may contract with a publisher to have their specific side-tab widgets inserted, embedded or otherwise displayed within the publisher's website, where the multiple merchants may share “space” or “time” (or both) to present their products and services to potential customers.

In accordance with the present invention, methods and systems for providing one or more e-commerce side-tab widgets have been developed that allow a web-based merchant to add such widgets to his/her own website (or blog or other web presence). In one embodiment of the invention one or more “side-tab” servers that has been given permission by a publisher (e.g., publisher's server) may generate and control one or more “side-tab widgets” associated with a particular merchant. The side-tab server may then control the widgets in order to embed, insert or otherwise display the generated one or more side-tabs at an unobtrusive display location, for example, along a margin of the publisher's web page. Further, the side-tab server may control one or more side tab widgets in order to embed, insert or otherwise display the generated side-tab widget(s) so that it will “slide out” when clicked on. hovered over or otherwise selected. In accordance with an embodiment of the invention, when opened (e.g., expanded), a side-tab may display or reveal, for example, a shopping page (or, perhaps, an advertisement) associated with the merchant so that the customer may complete a transaction or purchase directly from the web page without being redirected to the merchant's website.

In contrast to banner ads, the site-tabs generated by methods and systems of the present invention take substantially less advertising space on a publisher's web page. Further, the associated shopping cart/advertising information may only be visible when the side-tab is activated.

In an additional embodiment of the invention, more than one side-tab (associated with multiple merchants) may be displayed along the periphery of a publisher's web page, for example.

In yet an additional embodiment, a method for implementing Internet-based online shopping from a third party's website may comprise the steps of: generating a side-tab widget associated with a merchant; and controlling the display of the side-tab widget at an unobtrusive position within a third party website, and upon selection of the side-tab, further controlling the side-tab to slide open to display information associated with the merchant without being redirected to the merchant's website.

In another embodiment, a system for generating an online advertisement for a merchant within a publisher's web page may comprise one or more servers, wherein the one or more servers generates a side-tab widget associated with a merchant, and controls the display of the side-tab widget at an unobtrusive position within a third party website, and upon selection of the side-tab, further controls the side-tab to slide open to display information associated with the merchant without being redirected to the merchant's website. In an alternative embodiment of the invention, a side-tab widget may comprise a shopping cart for allowing online purchasing of a merchant's goods and services directly from a publisher's web page.

In yet other alternative embodiments of the invention, methods and systems may additionally comprise the generation of a side-tab widget that displays the products and/or advertisements most relevant to the publisher's website.

Other and further embodiments and aspects of the present invention will become apparent during the course of the following discussion and by reference to the accompanying drawings.

### BRIEF DESCRIPTION OF THE DRAWINGS

Referring now to the drawings,

FIG. 1 is a simplified block diagram of a publisher's web page including a side-tab widget associated with a particular merchant;

FIG. 2 is a simplified block diagram of the arrangement of FIG. 1, when the side-tab widget has been activated to display the information associated with the merchant;

FIG. 3 is a screen shot of an exemplary embodiment of the diagram of FIG. 1;

FIG. 4 is a screen shot of an exemplary embodiment of the diagram of FIG. 2;

FIG. 5 is a screen shot of an alternative embodiment of the type of merchant information that is displayed when a side-tab widget is selected and activated;

FIG. 6 is a screen shot of an exemplary organization of product offerings associated with a merchant;

FIG. 7 is a screen shot illustrating a number of different brands of products that may be offered by a particular merchant;

FIG. 8 is a screen shot of an exemplary side-tab widget that may be utilized to select a preferred language for a particular purchaser to use when browsing through a merchant's selection of products;

FIG. 9 is a screen shot of merchant information that may be displayed in a side-tab widget, the information including, for example, contact information, store policies, and the like;

FIG. 10 is a screen shot of a purchaser's shopping cart after a number of different products have been selected for purchase, wherein a shopping cart side-tab widget comprises price and quantity information and the ability to modify the quantity of items purchased, as well as the ability to add other items to the cart, or remove items from the cart; and

FIG. 11 is a screen shot of an exemplary side-tab widget that may be used to initiate a purchase or transaction.

### DETAILED DESCRIPTION, WITH EXAMPLES

Embodiments of the present invention, as will be described more fully below, are directed at improvements in online shopping. The improvements involve generating and controlling an advertisement associated with a particular merchant in the form of a side-tab widget on a publisher's website using one or more servers. It should be understood that each of the servers comprises the necessary processors and memory required to generate and control side-tab widgets. A side-tab widget may additionally include a shopping cart. Both the merchant's activities and publisher's activities may be controlled through the servers that are configured to store their specific information and communicate through via the Internet in a world-wide web (“web”) presence.

In order to assist in the understanding of the principles of the present invention, the following list of definitions is presented:
Publisher: a host of a website or blog (or other web presence) that presents various types of information of interest to different groups of individuals, and who permits a merchant to display his side-tab widget, for example, along an edge of the website.
Customer: refers to a person that uses a web browser running on a personal computer or mobile device to visit a publisher's website or blog.
Merchant: refers to a company or person that offers goods or services for sale through a presence on the Internet, including, in the context of the present invention, an organization that wants to advertise and/or sell goods or services through the Internet.
Widget: refers to icon or other visual indicator that is generated by a side-tab server and appears within a web page; when a user selects the widget an associated application may be executed within the web page.

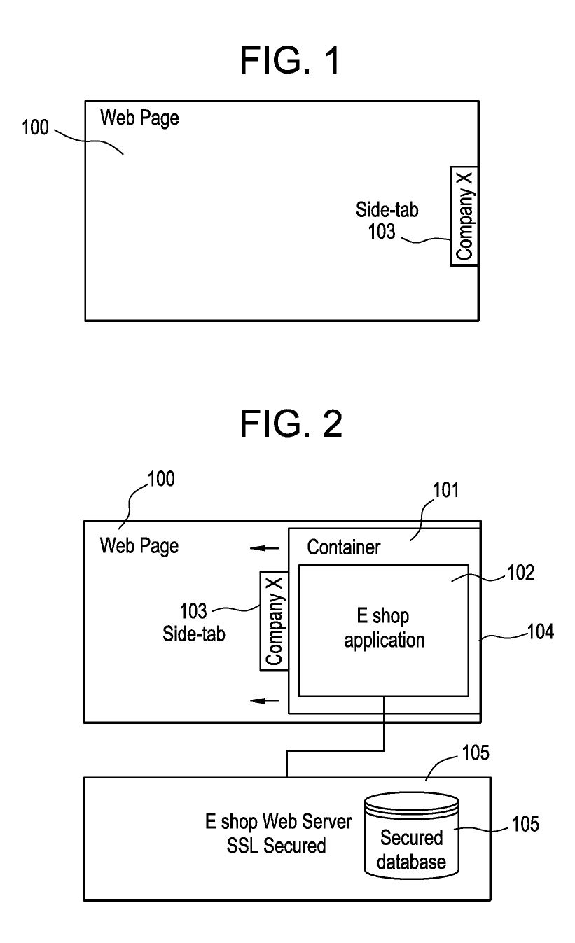

FIGS. 1 and 2 are simplified block diagrams showing the implementation of a side-tab widget for improving online shopping in accordance with one embodiment of the present invention. FIG. 1 shows an exemplary publisher's web page 100 (which in some cases may be a blog or any other type of web presence), where the page itself may contain a variety of different types of information. A side-tab widget 103 associated with a particular merchant (in case, shown as “Company X”) is generated by one or more servers and then controlled by the one or more servers to embed, insert or otherwise display, for example, the widget at or along a particular location, such as side edge 100-S of web page 100 in a manner that is relatively unobtrusive and does not interfere with a user's browsing within the page.

In accordance with an embodiment of the present invention, when a customer becomes interested in a product offering of Company X by virtue of his/her study of web page 100, the customer can merely click on or otherwise select (“clicking on” and “selection” are used synonymously herein) side-tab widget 103, which will then be operable to “slide out” or otherwise unobtrusively expand along a portion of web page 100 and present (e.g., display) detailed information associated with Company X—including the ability to directly purchase products from Company X.

FIG. 2 illustrates the same web page 100 as shown in FIG. 1, in this case when side-tab widget 103 has been selected and then activated and has slid over to the left, for example, to display or reveal a container (i.e., “frame”) 101 associated with Company X (the direction of movement illustrated by the arrows in FIG. 2). Embedded within container 101 is a specific e-shopping application 102 associated, for example, only with Company X, where application 102 is shown as linked to Company X's e-shop web server 105 and database 106. While information displayed on publisher's web page 100 may not necessarily be secure, Company X's transactions within container 101 (particularly a shopping purchase) are intended to be secure. Indeed, from a customer's perspective, the transaction is the same as that conventionally experienced upon redirection to Company X's own web page.

Once a customer has completed a transaction, or is finished with viewing the particular information associated with Company X, he/she can then either re-select or click again on side-tab widget 103 (or close out in any other manner), and container 101 will slide back or contract to the right, for example, leaving only side-tab widget 103 visible (as shown in FIG. 1). It should be noted that the specifics of performing an online transaction are not germane to the subject matter of the present invention and, therefore, will not be described in detail. It should be further noted, however, that while the content of web page 100 itself may not be secure, the communications between e-shopping application 102 and web server 105 are secure.

In an additional embodiment of the invention, multiple side-tabs widgets may be generated and then controlled to insert, embed or otherwise display (collectively referred to as “display” herein) such widgets within a particular publisher's web page, where each side-tab widget may be associated with a different merchant. Control of the multiple side-tab widgets may vary. For example: multiple side-tabs widgets may be displayed at the same time; different side-tab widgets may be displayed at different times; or some combination of the two methods. Yet further, another embodiment of the invention includes controlling the display of one or more widgets such that every time web page 100 reloads, a different merchant's side-tab may be displayed. In this way, a contextual matching may be used such that the more relevant merchant/advertiser is shown, based on the particular content of web page 100.

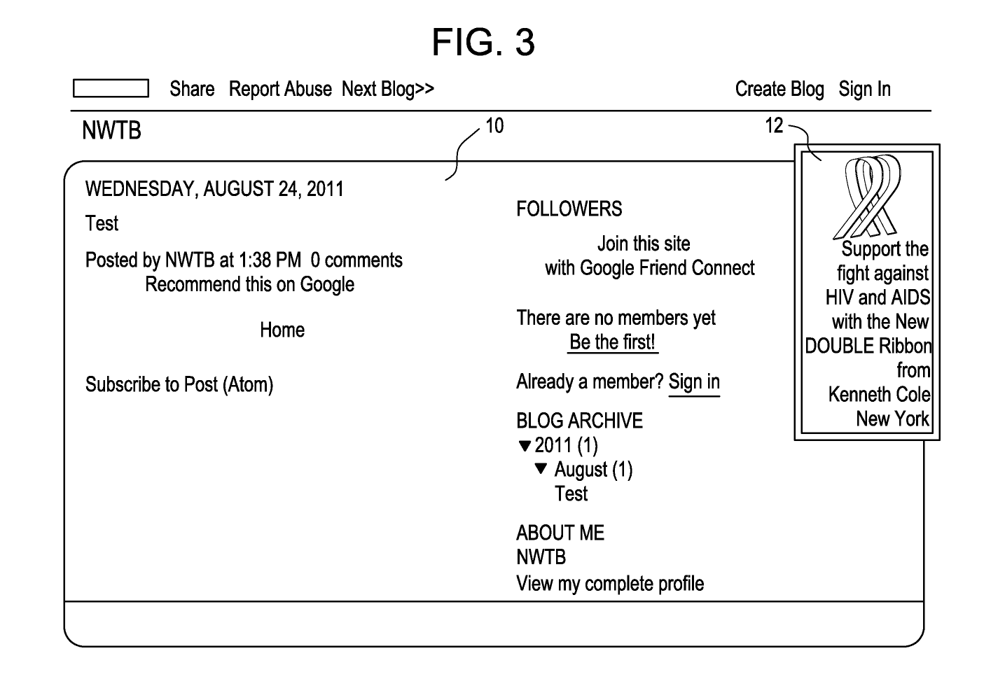

FIG. 3 is a screen shot showing an implementation of the side-tab widget in accordance with another embodiment of the present invention. In this case, an exemplary website 10 associated with a publisher NWTB is shown. A side-tab widget 12, associated with a specific organization is shown displayed along the right-hand edge of website 10, for example. As described above, side-tab widget 12 may be associated with a particular organization that has purchased this “space” from the publisher. However, unlike banner ads, the unobtrusive location and/or nature of side-tab widget 12 is considered to be a more attractive option to publishers.

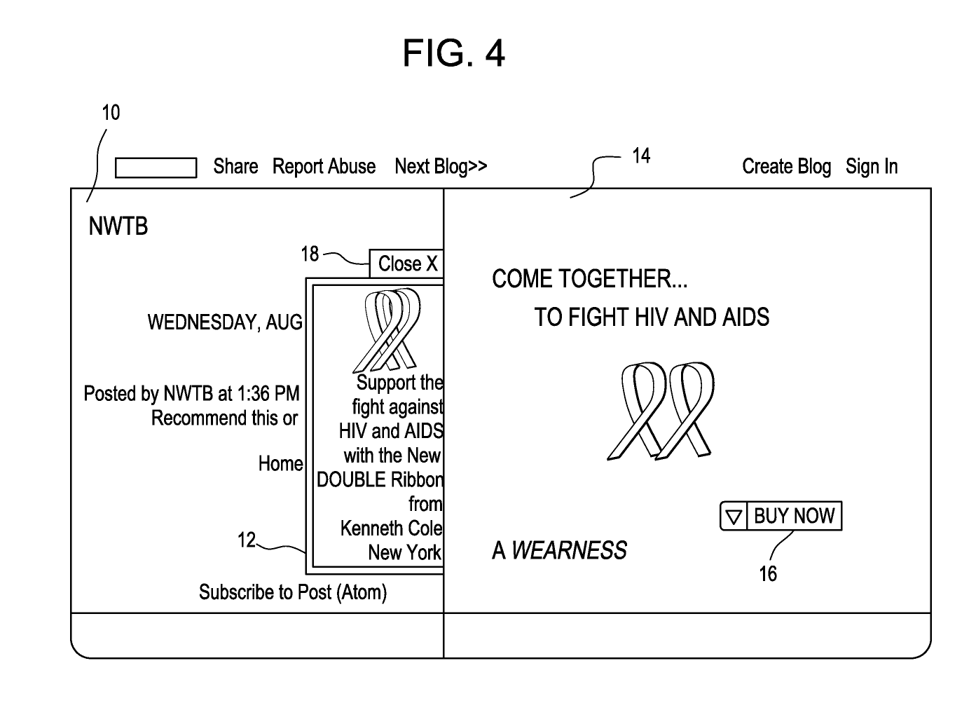

In the embodiment shown in FIG. 3, side-tab widget 12 is in its inactive state. That is, in such a state widget 12 is controlled so that a minimal amount of information identifying the particular merchant (or “source”) associated with the tab is displayed. An individual browsing website 10, interested in learning more about the information shown in side-tab widget 12 (or perhaps making a purchase from the merchant shown on the tab), may then click on, hover over or otherwise select tab 12 causing the tab 12 to “slide” open or otherwise expand to cover a portion of website 10. FIG. 4 depicts a screen shot of the same embodiment, when side-tab widget 12 has been selected, activated and slid across to expose its contents. In this embodiment, the full e-commerce container/frame 14 of side-tab widget 12 may include an advertisement and/or an offer to purchase an item. A customer may then quickly and easily complete a transaction or purchase by, for example, clicking on the “buy now” link 16 within container 14. By again clicking on or otherwise selecting side-tab widget 12 (or clicking on the created “close” feature 18), side-tab widget 12 may, for example, slide back into its unobtrusive “closed” position along the edge, for example, of website 10 (that is, returning to the position shown in FIG. 3).

In contrast to known, conventional methods, there is no need in the methods and systems provided by the present invention for a customer to first browse a webpage, view an advertisement for a particular merchant and then “click through” to the merchant's website in order to begin the purchasing process. Instead, in accordance with embodiments of the present invention, the merchant's website does not need to be visited to complete a transaction and/or purchase, for example.

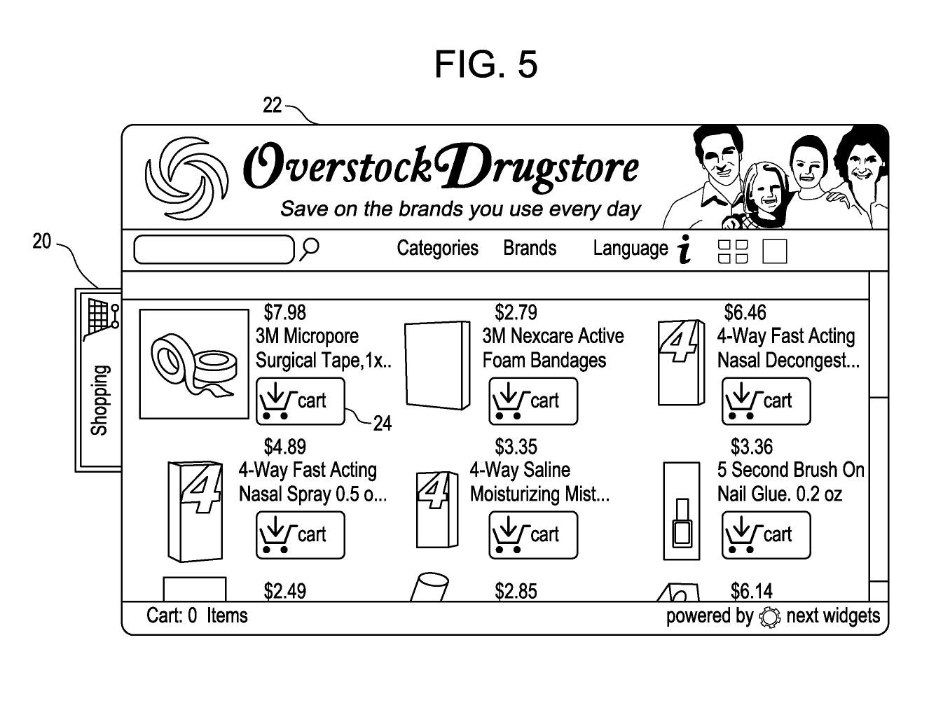

FIG. 5 illustrates another side-tab widget 20 and associated merchant information 22 that may be generated or otherwise created by a merchant server or a server associated with a merchant and inserted, embedded or otherwise displayed within a publisher's website, where in this exemplary embodiment information 22 includes a number of different items that may be purchased. In this embodiment, the content of the merchant's online shop may be shown to the customer, displaying the image, title, description and prices of various products. By clicking on or otherwise selecting one of the elements, the customer may proceed to view a detailed description of a specific product offering. A “purchase” can be affected by, for example, clicking on the shopping cart icon 24 located next to a specific product.

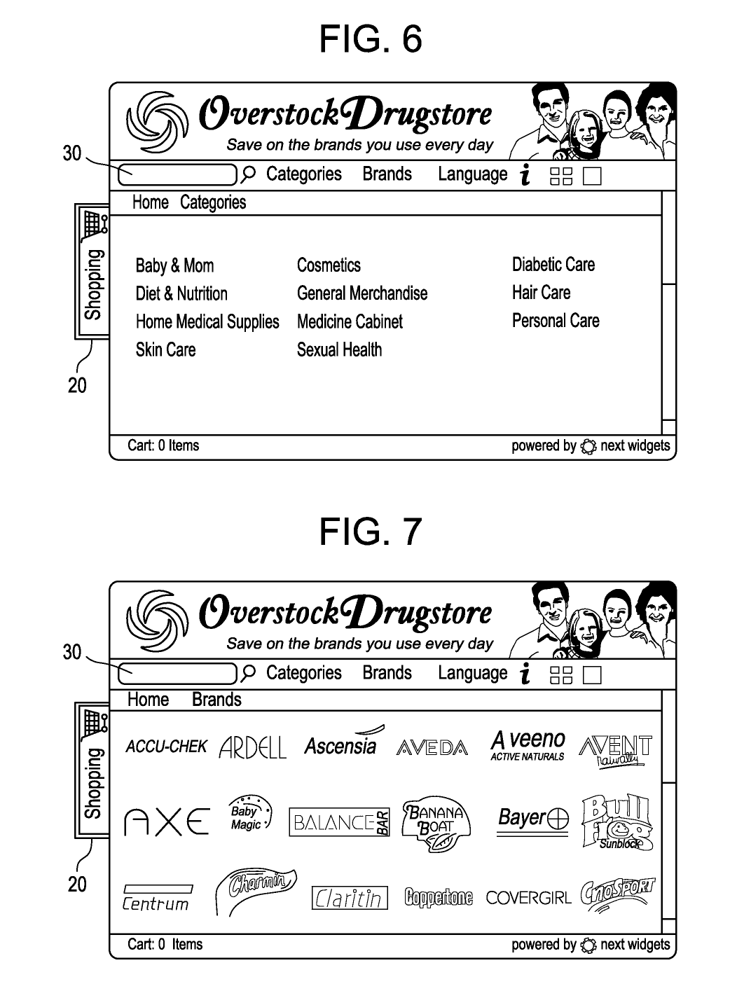

Reference is now made to FIG. 6, which illustrates one exemplary embodiment of the invention directed at a method and related system for grouping products within a side-tab widget. In this embodiment, the products may be grouped in categories and subcategories, and the widget comprises a search box 30 that may look for a requested product, and then initiate a process of returning information including detailed descriptions and prices. As with the embodiment illustrated in FIG. 5, side-tab widget 20 may be used to slide or otherwise expand/contract the widget “open” and “closed” across a publisher's website, for example. FIG. 7 illustrates an additional embodiment where the widget may display brands of all of the products that are in a database of a merchant's online shop, illustrating yet another way that a customer can browse through a selection of different products.

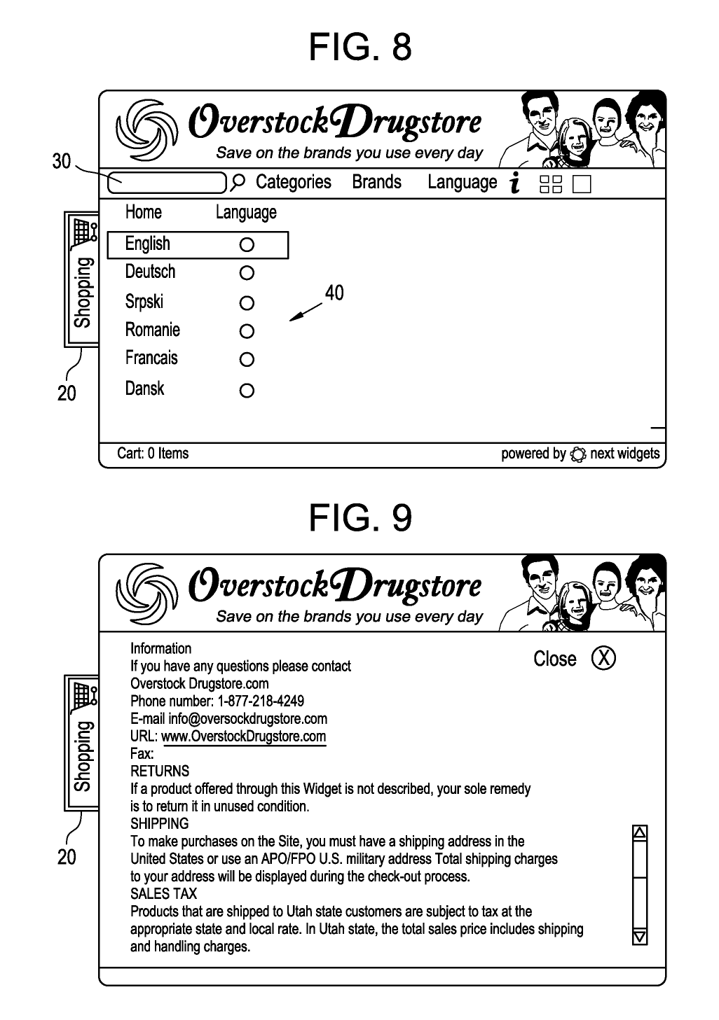

In yet another embodiment of the invention, a side-tab widget may be generated that allows for one or more languages to be displayed within the widget and one of the displayed languages to be selected/modified, as shown in FIG. 8. For example, FIG. 8 depicts a listing 40 of different languages that may be chosen by a customer. Referring now to FIG. 9, a further exemplary side-tab widget is shown that may take the form of a page containing information about the merchant (e-mail, website, telephone, address, etc.). Additional information regarding the conditions of a sale (e.g., return policy, warranty, etc.) may be included on this page, where all of this information may be useful for a potential purchaser.

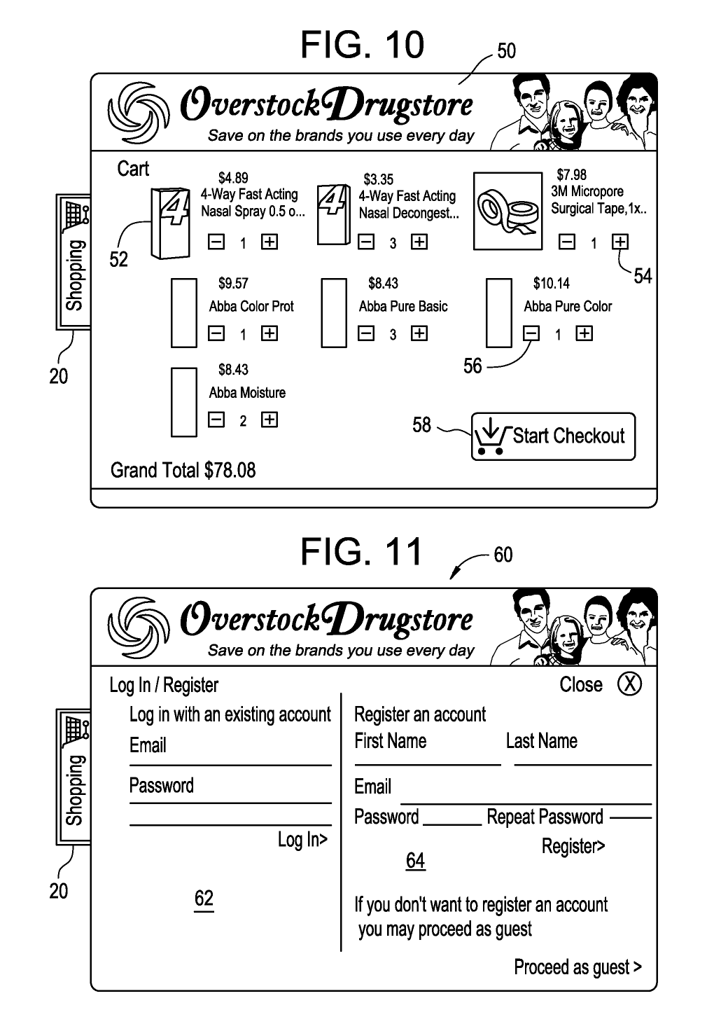

In accordance with embodiments of the invention, once an individual has selected several products to purchase, he/she may see the total balance of the products in the “shopping cart”/basket within the exemplary side-tab widget 50 shown in FIG. 10. Included in the embodiment shown in FIG. 10 is an additional option to change the quantity of a particular item being purchased (one item, such as 52, illustrated by its package). In this particular embodiment a “plus” (+) button 54 and a “minus” (−) button 56 may be used to change the quantity of an item to be purchased. When shopping or a transaction is completed or finished (e.g., a ‘grand total’ is displayed), the transaction may continue by clicking on or otherwise selecting the “start checkout” button 58.

Initiating the checkout process brings up a transaction widget 60, as shown in the embodiment of FIG. 11, which may then prompt the purchaser/user to either fill in information for an existing account (shown in left-hand portion 62), or register a new account (or proceed as a ‘guest’), as shown in right-hand portion 64. As with other on-line purchasing processes, information such as name, password, email, account information, etc., may be used to complete the transaction or purchase (e.g., utilizing a secured server, as discussed above in association with FIG. 2).

As can be seen from the above description, the format of the side-tab widgets (especially when in a minimized state) provides publishers with the advantage of utilizing very little, existing screen “real estate” that may otherwise be sold to banner advertisers, or used for a publishers own content. The unobtrusive nature of the side-tab widgets of the present invention is another advantage. Additionally, as mentioned above, the ability to display the most relevant products or advertisements based on the context of the publisher's website within a side-tab widget is also highly advantageous. The use of targeted marketing systems and/or semantic analysis allows the methods and systems of the present invention incorporating side-tab widgets to automatically determine which offers are the most relevant one for each publisher's web page. Thus, if a merchant has associated side-tab widgets displayed on different publishers' web pages, these side-tabs may offer different products or services based on the context.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention, provided they come within the scope of the appended claims and their equivalents.

What is claimed is:

1. A method of implementing Internet-based online shopping from a third party's website, comprising the steps of:
generating a side-tab widget associated with a merchant; and
controlling the display of the side-tab widget at an unobtrusive position within a third party website, and upon selection of the side-tab, further controlling the side-tab to slide open to display information associated with the merchant without being redirected to the merchant's website.

2. The method as in claim 1 wherein the display information includes products or services for sale and an icon to activate a sales transaction with the merchant directly from the merchant's site.

3. The method as in claim 1 wherein the generation of the side-tab presence widget further comprises developing a content-based side-tab widget based on information displayed on the third party's website.

4. The method as in claim 1 further comprising generating multiple, different side-tab widgets, wherein each side tab is associated with a different merchant.

5. The method as in claim 4 further comprising controlling the display of the generated, multiple side-tab widgets on the third party's website.

6. The method as in claim 4 further comprising controlling the display of the generated, multiple side-tab widgets so that the side-tab widgets are simultaneously displayed at different locations within the third party's website.

7. The method as in claim 4 further comprising controlling the display of the generated, multiple side-tab widgets so that the side-tab widgets are simultaneously displayed at different times within the third party's website.

8. A system for generating an online advertisement for a merchant within a publisher's web page, the system comprising:
one or more servers,
wherein the one or more servers generates a side-tab widget associated with a merchant, and controls the display of the side-tab widget at an unobtrusive position within a third party website, and upon selection of the side-tab, further controls the side-tab to slide open to display information associated with the merchant without being redirected to the merchant's website.

9. The system as in claim 8 wherein the display information includes products or services for sale and an icon to activate a sales transaction with the merchant directly from the merchant's site.

10. The system as in claim 8 wherein the one or more servers further generates a content-based side-tab widget based on information displayed on the third party's website.

11. The system as in claim 8 wherein the one or more servers further generates multiple, different side-tab widgets, wherein each side tab is associated with a different merchant.

12. The system as in claim 11 wherein the one or more servers further controls the display of the generated, multiple side-tab widgets on the third party's website.

13. The system as in claim 11 wherein the one or more servers further controls the display of the generated, multiple side-tab widgets so that the side-tab widgets are simultaneously displayed at different locations within the third party's website.

14. The system as in claim 11 wherein the one or more servers further controls the display of the generated, multiple side-tab widgets so that the side-tab widgets are simultaneously displayed at different times within the third party's website.

15. The system as in claim 8 wherein the side-tab widget comprises a shopping cart for allowing online shopping of a merchant's goods and services directly from a publisher's web page.
